(19) United States
(12) Patent Application Publication
(10) Pub. No.: US 2006/0107714 A1
(43) Pub. Date: May 25, 2006

(54) Apparatus and method for composting waste with recirculation of air and gaseous materials and collection of liquid

(76) Inventor: Peter Wadewitz, Glenelg East (AU)

Correspondence Address: NATH & ASSOCIATES, 112 South West Street, Alexandria, VA, 22314, US

(21) Appl. No.: 10/528,779

(22) PCT Filed: Sep. 24, 2003
(86) PCT No.: PCT/AU03/01252

§ 371 Date: Aug. 5, 2005

(30) Foreign Application Priority Data
Sep. 24, 2002 (AU) 2002951622

(51) Int. Cl. C05F 11/08

(52) U.S. Cl. 71/8; 435/266; 435/290.1

(57) ABSTRACT

An apparatus and method for the treatment of composting materials in which the aqueous liquids are arranged such that they are to be held at a level which is lower than any one or more of the gaseous outlets effecting gaseous distribution below the composting materials.

This invention relates to the treatment of waste materials and, in particular, to both method and apparatus for assisting transformation of such materials often referred to as composting.

### BACKGROUND OF THE INVENTION

There is a serious worldwide problem associated with the storage and disposal of waste materials especially those that are by their nature potentially odiferous during their breakdown.

I have discovered that if such materials are held and treated in a different way than has hitherto been the case, then there can be significantly improved reduction in unpleasant odour and further there can be, in the same process, a reduction in the number of pathogens that may, in the first instance, exist in the materials.

Such previous discovery has used techniques to promote the development of anaerobic bacteria in the composing materials rather than aerobic bacteria.

While this has been considered previously to promote odiferous byproducts, it has been found that if air and gaseous products from the composting process itself are caused, from time to time, to be blown through the composting material and especially if this is passed through a biological filter, then the level of noxious odours that are released when any chamber within which the composting effect is being nurtured is opened, that these odours are very much less objectionable than has been expectations in previous systems.

### PROBLEM OF THIS INVENTION

One of the problems that arises with such a system, however, is that during the breakdown process, some materials lose water which then seeps to a bottom of any chamber.

In order to effect a distribution of the atmosphere through the composting material, there has been a distribution arrangement so that the atmosphere being recirculated will be distributed to some extent uniformally throughout the area

The problem to which this invention is directed, however, is that when the composting material is breaking down, this will release water that is otherwise bound up in the material and this can then gather in the bottom of the chamber where it will settle and build up during the composting period.

As the level of liquid rises, air that was previously passing directly from beneath the composing material into the composing material will now necessarily pass through the liquid.

The discovery has been that by having this recirculation gases passing through liquid prior to being released into the composting material has resulted in a return to at least a modest extent of some noxious odours that previously were not experienced.

It has still not been established precisely why there should be such an increase in odour although one theory suggests that some of the useful gas such as perhaps a higher than usual ammonia, or even a useful bacterium spore is being selectively separated by solution into the water and is therefore either reducing the effectiveness of the gas or the recirculation technique or is carrying further of the gases resulting from some decomposition within the water or other liquid itself.

### BRIEF DISCLOSURE OF THE INVENTION

In one form of this invention, although it need not necessary be the only or indeed the broadest form of this, there is proposed therefore a method of treating compositing materials substantially as described where, however, aqueous liquids are arranged to be held at a level which is lower than any one or more of the gaseous outlets effecting gaseous distribution below the compositing materials.

It is reasonable to say that incidental occurrences or even one or two apertures where there are a multiple of such apertures which might cause the issuing gaseous recirculating material to pass through liquid or not of itself give rise to a major rise in noxious odours.

However, by removing substantially the water from above any outlet apertures, the result has been of great significance in maintaining the very low odiferous character of the resulting materials during the rotting or composing phase.

In preference, the arrangement is achieved by providing within a chamber, means to hold the rotting material above a lowermost floor and to effect a location of gaseous product recirculating into a location which is at least substantially below the composting material holding area but above a liquid containable sump.

Such a sump can be defined by having a floor, apertures passing through the floor such that liquid passing onto the floor will flow through the apertures into an underneath sump and there being means to effect passage of air or other recirculating gases immediately above the separating floor.

In preference, the floor is caused to be sloping when the chamber is positioned on a horizontal floor or support such as the ground and there is a slot at one end which is the lower end of the floor such that water will pass down the floor into the slot and then into the underneath sump.

In preference, the process described is one in which the recirculation of gases is caused to occur on a regular basis but without the addition of external air, at least to any substantial extent from time to time.

Generally, the composting process relies upon the nature of the rotting materials to provide a reasonable balance of nitrogen providing source materials such as meat and carbon supplying material such as vegetables, carbon in its general form such as wood chips, straw or vegetables or fruits, and the material as it is loaded into a chamber is divided so that there will be in preference a relatively general mixture of carbon supplying and nitrogen supplying materials.

In the event of lower protein materials, it is noticed that a build up of ammonia might be slightly less but in general the process still seems to be of great benefit and keeps the level of noxious odours very low indeed.

In preference, the chamber is defined by a bin which has an upper opening, side walls and a bottom where the whole of chamber can be closed and be at least substantially sealed from an external atmosphere and where there are conduits attached and means to effect, from time to time, passage of any retained atmosphere and gaseous fluids resulting from the rotting material which, over a period of time, will result in a substantive increase in the temperature to which the rotting materials reach and also cause the increase in the level of the nitrogen within the gaseous fluid.

In preference, such recirculation shall take place, from time to time, which may typically be in the order of an hour recirculation with an hour no recirculation and such a cycle being repeated over a period of days.

Typically, the composting process will take some many days and there is this recirculation occurring on a cyclic basis, from time to time, through all of the composting period.

The chamber is adapted to be open from time to time to introduce additional material to be added to the composting material but such opening will be on the basis that it will be relatively temporary and will thereafter be closed again so that it can be expected that not a great deal of the gaseous materials will release from the closed circuit system.

In preference, there are means to effect an extraction of any water collected in the area at the bottom of the chamber and in a further feature this is reintroduced into a top of the chamber, from time to time, so that this liquid will then again seep through the composting material.

The surprising factor here is that as the composting material breaks down, the development of appropriate bacteria which are firstly anaerobic at least to a substantial extent and are resistant to degradation in a higher than normal ammonia atmosphere are also infecting the liquid as it seeps through and therefore further treating materials carried by the liquid through the compositing material and, as far as can be established so far, having the result that the liquid itself then is actually further cleansed.

In a further preferred arrangement in the alternative, the liquid is transferred, from time to time, into a separate settlement chamber where it is held under conditions of isolation and further encouraged to nurture any bacteria to the effect that there is a biological cleansing of the material akin to treatments known to exist currently.

In preference, the organic material to be composted comprises the bodies of dead poultry and the packing of the container includes a first covering of woodchips then successive layers of bodies of poultry, a layer of woodchips, a layer of poultry and so on.

A further form of this invention then, can be said to reside in a method of treating materials to be composted which includes the steps of containing such materials within a closed container then effecting a first covering of woodchips then successively a layer of organic bodies to be composted and a layer of absorbing woodchips, pumping air into the container at one part of the contained body of material, and taking the air having passed through the material from the container so that it, and it only, will be substantially recirculated back to an introduction location of the material so that gaseous products of any decomposition of the materials will be kept within the container or its connected conduits, the liquid formed as a result of the composting passing through the floor means and held at a level lower than that of the supply conduits.

Further, it has been discovered that if such recirculation occurs on a regular basis through a decomposing period, which can be several weeks, nonetheless, such treatment is sufficient to maintain a dominance of aerobic bacteria with significant improved results. In preference, the collected liquid is extracted from the lower most level and reintroduced in to the top of the container.

In preference, the extraction of liquid and reintroduction to the top of the container is effected from time to time through the period of composting.

This can be achieved periodically by a manual operation if required, but an automatic system would be preferred so that this would then rely less on the user.

For a better understanding of this invention it will now be described with the assistance of drawings wherein:

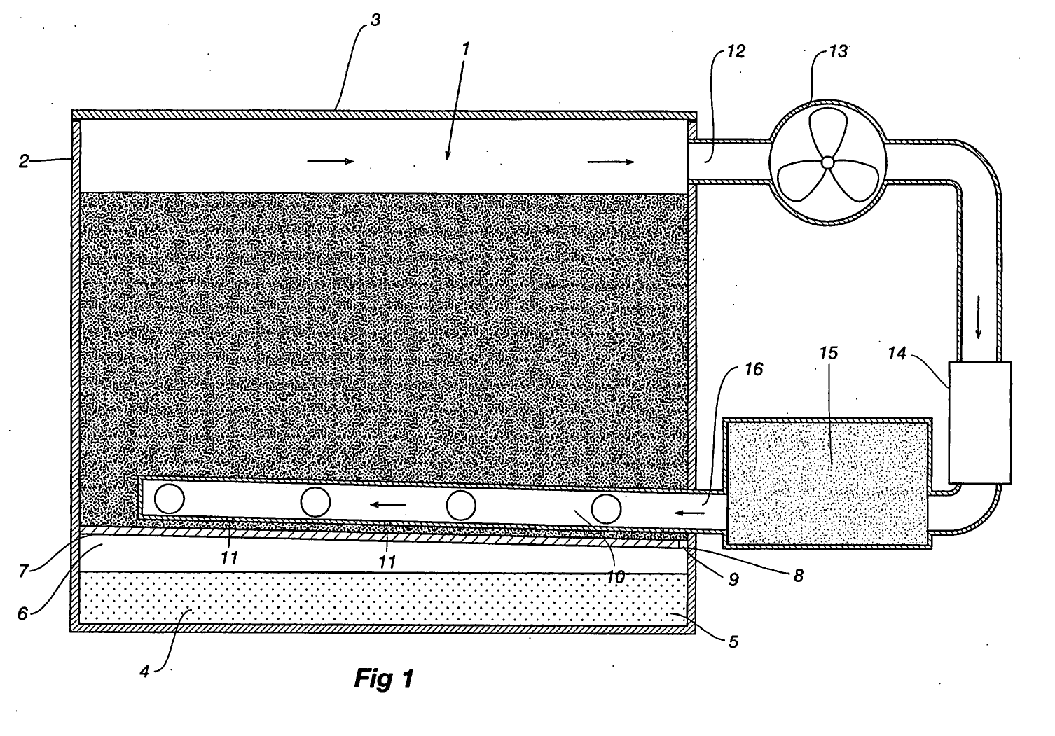

FIG. 1 is a schematic arrangement showing a chamber containing composting materials, a supporting floor for the composing materials on which a network of conduits lie, and beneath this, a receiving sump for holding such liquid; and

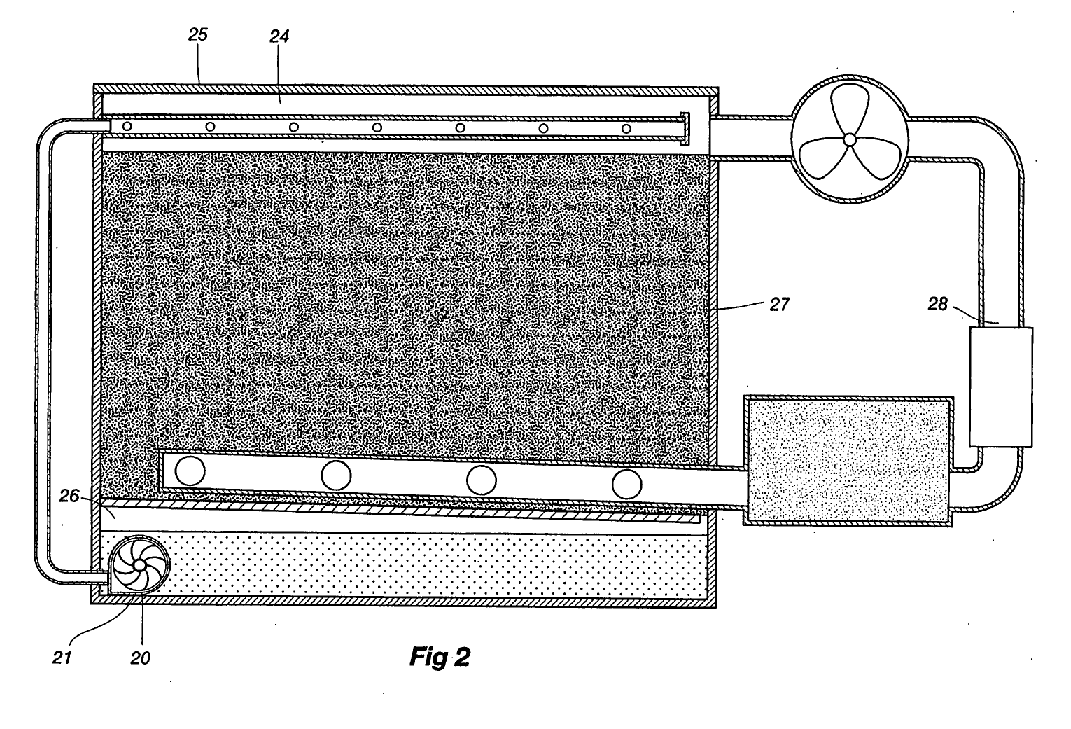

FIG. 2 is an alternative arrangement again shown in schematic arrangement in which there is a collection point at a bottom of the sump arranged to, from time to time, distribute liquid gathered back into a top of the chamber.

Now referring to the drawings in detail, there is a chamber 1 which comprises a bin made from walls 2, a top lid 3 which can be opened, from time to time, but otherwise when closed seals the bin from external atmosphere, and a sump 4.

The sump 4 is defined by having a floor 6 with a lowermost part 5 from where liquid gathered in the sump can be extracted and either diverted to a septic process or recirculation.

Immediately above the sump is a floor 6 which is arranged to be floating so that there is a higher side 7 and a lower side 8, the lower side 8 being separate by a gap 9 from the side of a wall 2 so that as any rotting material releases water, this seeps through onto the floor, flows through the gap and into the sump.

There is a network of conduits with lowermost apertures shown generally at 10 connected to a recirculation arrangement so that the internally retained atmosphere will be recirculated, from time to time, in this case on an hour by hour basis, that is, one hour on and one hour off and the conduit network is supported above the floor 6.

The air and other gaseous fluids which includes over a period of time increased ammonia by reason of breakdown of nitrogen containing materials are extracted from a top of the chamber 1 through extraction conduit 12 through blower 13 which causes these materials to firstly pass through a condenser 14 and a biological filter 15 whereupon there is a return conduit 16 back to the network of conduits across the floor of the chamber 1.

As is shown in FIG. 2 in particular, there is a recirculation of liquid which is extracted at 20 in this case which is then caused to be passed through a submersible pump 21 and there is a distribution of such liquid into the top area 24 of the bin in this case 25.

Again, however, there is a floor 26 supporting the composing material 27 and an appropriate recirculation network 28 as previously described in relation to the first embodiment.

While not specifically shown, there are also means to effect cleansing from time to time of the sump area so as to also assist in removal of fines that would settle over a period in this area.

Throughout this specification the purpose has been to illustrate the invention and not to limit this.

The claims defining the invention are as follows:

1. Apparatus for the composting of material which includes a container which has an openable lid which closes with respect to its surrounding perimeter by means of a resilient seal so as to provide a substantially airtight closure with the container, across the bottom of the container being a series of conduits which have a plurality of holes passing through the walls thereof which are collectively fed to a single exiting conduit which feeds into a pump and through a filter back into a supply conduit, wherein the aqueous liquids formed during treatment are held at a level lower than that of the supply conduits, by a combination of a sump below the supply conduits and floor means to hold the material being treated above the sump.

2. The apparatus of claim 1, further characterized in that the floor means has a plurality of apertures disposed thereon.

3. The apparatus of claim 1 or 2, in that the floor means is sloping.

4. The apparatus of claim 3, wherein the plurality of apertures disposed on floor means are located at a lowermost point to allow liquid to pass through and into the sump.

5. The apparatus of anyone of the preceding claims further characterized in that there is a pump means to pump the liquid from the lowermost area to disperse over the top of the material to be composted

6. The apparatus of any one of claims 1-5 further characterized in that there are means with which to access the liquid in the sump from outside the container.

7. The apparatus as in any one of the preceding claims further characterized in that there are number of chambers in connection with the lowermost for isolation of the liquid material produced.

8. A method of treating materials to be composted which includes the steps of containing such materials within the closed container as described in any of the apparatus claims then effecting a first covering of woodchips then successively a layer of organic material to be composted and a layer of absorbing woodchips, pumping air into the container at one part of the contained body of material, and taking the air having passed through the material from the container so that it, and it only, will be substantially recirculated back to an introduction location of the material so that gaseous products of any decomposition of the materials will be kept within the container or its connected conduits, the liquid formed as a result of the composting passing through the floor means and held at a level lower than that of the supply conduits.

9. The method of claim 8, wherein the collected liquid is extracted from the lower most level and reintroduced in to the top of the container.

10. The method of claim 9, wherein the extraction of liquid and reintroduction to the top of the container is effected from time to time through the period of composting.

11. The method of claim 8, wherein the liquid is collected and held for a period of time to encourage bacteria growth.

12. A method of treating materials to be composted as in any one of claims 8-11 further characterised in that there are conduits attached to the container which are also coupled to an air pump so that the air pump will cause the air to be extracted through one conduit and to be introduced back into the container through the other conduit.

13. A method of treating materials to be composted as in any one of claims 8-12 further characterised in that the recirculation is effected from time to time through the period of composting.

14. A method of treating materials to be composted as in any one of claims 8-13 further characterised in that the recirculation of the air and gases is through a biofilter in the pathway of such recirculating gases.

15. A method of treating materials to be composted as in the immediately preceding claim further characterised in that the biofilter includes compost or similar organic material through which the air to be filtered is passed.

16. A method of composting as in any one of claims 8-15 wherein the layer of organic material to be composted is a layer of bodies.

17. A method of composting materials as in any one of claims 8-16, which are high in protein content including the steps of holding the composting materials in a closed container and recycling through the material substantially only the air and any resultant gases given off from the composting materials.

18. A method as in the immediately preceding claim further characterised in that there are means to effect a cyclic operation of a pump so that it can be switched on and switched off over a decomposing period according to a pre-arranged program.

19. A method of composting which includes the steps of placing the materials to be composted into a container, sealing the container and then blowing in a recycling manner substantially only the air and gases contained within the container through the composting materials for a period of time to collect and distribute ammonia sufficient to allow for a substantial buildup in concentration to a pathogen killing level of ammonia derived from the composting materials, maintaining such circulation for a sufficient period of time so as to effect a substantial pathogen kill in the composting material, and then collecting the liquid produced during the composting from a chamber positioned below the level of the material.

20. A method as in one of the preceding method claims further characterised in that the composting materials are placed in layers with materials separating the respective layers, which are porous.

21. The apparatus as substantially as hereinbefore described with reference to the accompanying drawings.
